(19) United States
(12) Patent Application Publication
(10) Pub. No.: US 2006/0291005 A1
(43) Pub. Date: Dec. 28, 2006

(54) Method of setting image reading conditions for an image reading apparatus and an image reading apparatus

(75) Inventor: Daisuke Genda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/407,266

(22) Filed: Apr. 20, 2006

(30) Foreign Application Priority Data
Jun. 28, 2005 (JP) JP2005-188014
Dec. 12, 2005 (JP) JP2005-358196

(51) Int. Cl. H04N 1/04

(52) U.S. Cl. 358/474

(57) ABSTRACT

An image reading apparatus which communicates with another image reading apparatus through a network has a reading device to read document images and generate image data, a CPU (reading control device) to control the reading device according to a reading condition, and a communication device. A local image reading apparatus can send at least part of image reading condition to a remote image reading apparatus by the communication device in the shared reading mode and the remote image reading apparatus receives the image reading condition from the local image reading apparatus via the communication device and controls the reading device according to the received image reading condition.

### BACKGROUND

1. Field of the Invention

This invention relates to a method of setting image-reading conditions which enables multiple image reading apparatus to share image-reading conditions and an image reading apparatus which can read images of a series of document pages by sharing the image-reading conditions with the other image reading apparatus.

2. Description of the Related Art

Usually, document images and the other images are scanned into image data by a scanner. The image data are printed into copies and distributed. However, when a lot of documents are to be scanner, one scanner is not enough and it takes a lot of time to scan although the scanning capacity is dependent upon the ability of an automatic document reader of the scanner. To solve such a problem, a system has been proposed which has multiple scanners connected in a network and scans lots of documents fast by sharing the documents with the scanners. (See Japanese Non-Examined Patent Publications H10-191011 and 2000-224369.)

Such a system has multiple scanners of a kind connected in a network. A personal computer or server (hereinafter called a server or the like) connects these scanners, determines a sequence of scannings and a method of combining image data, and instructs the scanners to scan data. Image data read by the scanners are sent to the server and the like through the network and combined into the original images according to the sequence of reading.

However, in the above conventional Shared Reading system, only the personal computer or server sets information of image data combination and sends it to the scanners. Therefore, if documents are placed on the scanners in a wrong sequence, final image data pages may be mixed up. Further, the scanners in such a reading system must be of the same type or functionally identical. Therefore, when scanners are not of the same type or functionally unidentical, the dispersed image reading be done less efficiently. Even if the personal computer or server determines a scanning condition of the scanners, the scanning condition may not be fit for scanners. In such a case, the scanners may scan images under improper scanning conditions and consequently, the final image data may not be preferable and far from what is expected.

The present invention may comprise a reading condition setting method for an image reading apparatus having the steps of: setting a reading condition for reading an image to a local image reading apparatus; and applying at least a part of the reading condition to an image reading by a remote image reading apparatus.

The present invention may comprise an image reading apparatus having a local image reading apparatus which communicates with a remote image reading apparatus through network, including: a reading device to read an image of a document and to obtain image data; a control device to control the reading device according to a reading condition; and a communication device to send at least a part of the reading condition to the remote reading apparatus.

The present invention may comprise an image reading apparatus having a local image reading apparatus which communicates with a remote image reading apparatus through network, including: a reading device to read an image of a document and to obtain image data; a control device to control the reading device according to a reading condition; and a communication device to send at least a part of the reading condition to the remote reading apparatus.

The invention itself, together with further features and attendant advantages, will best be understood by reference to the following detailed description taken in conjunction with the accompanying drawings.

### BRIEF DESCRIPTION OF THE DRAWINGS

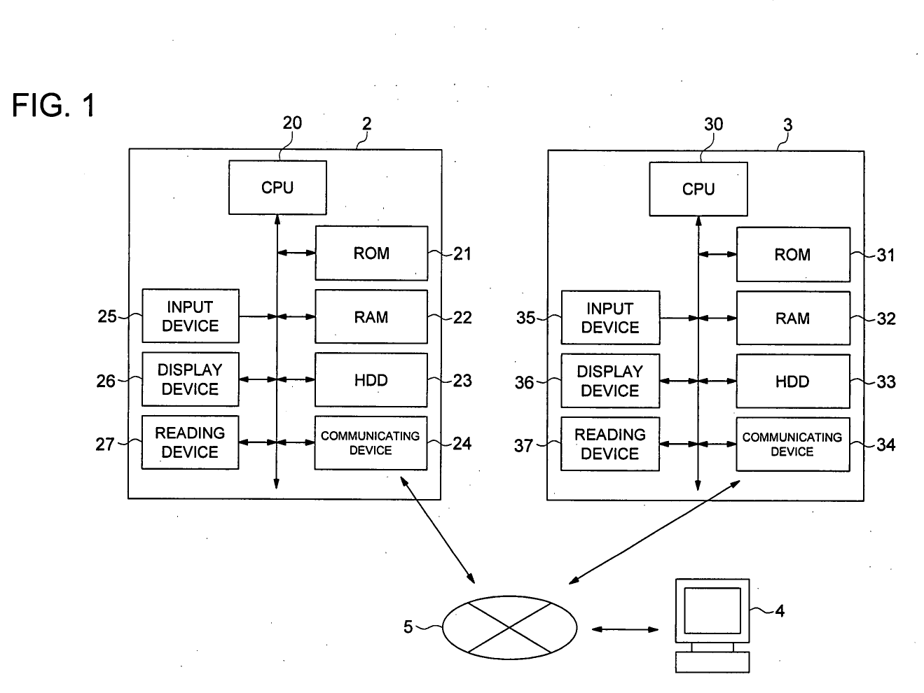

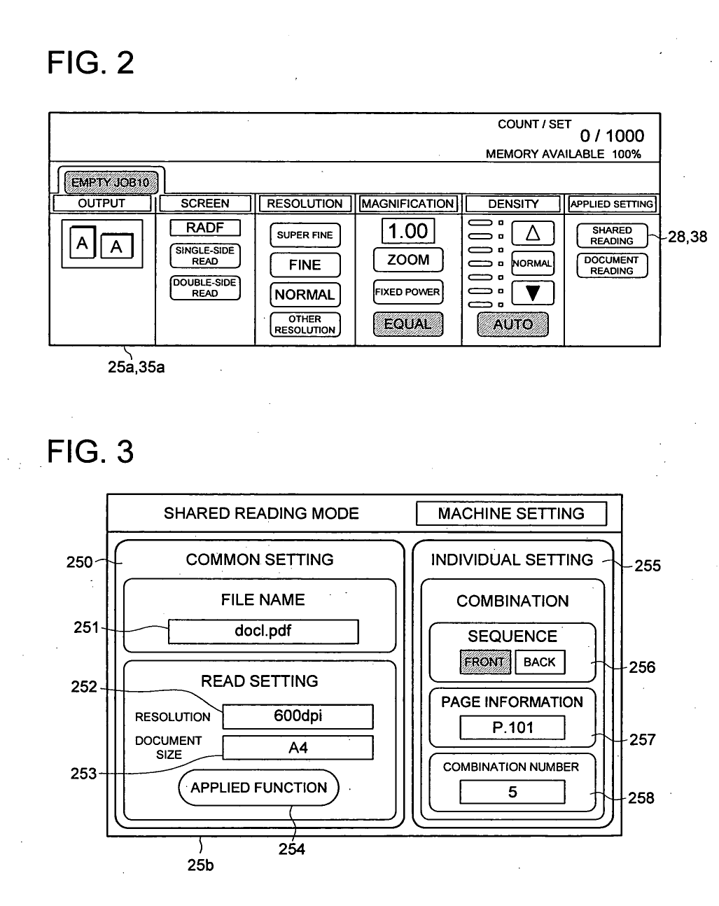

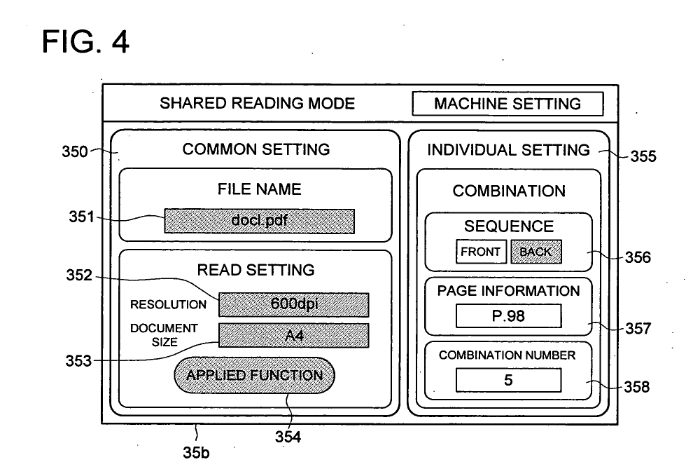

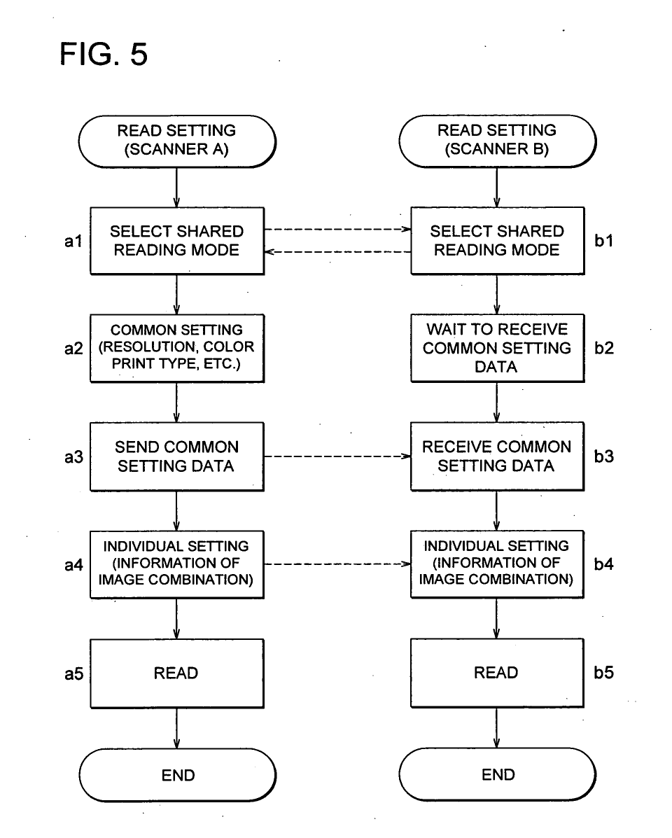

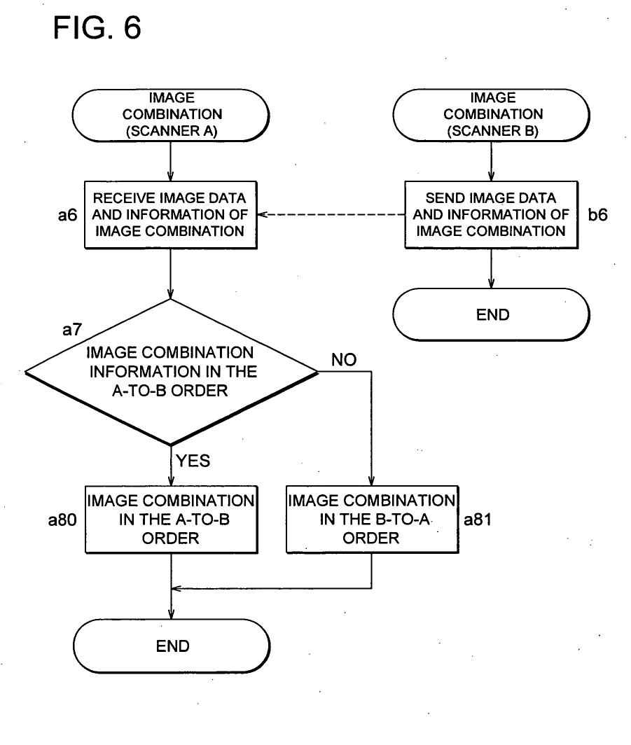

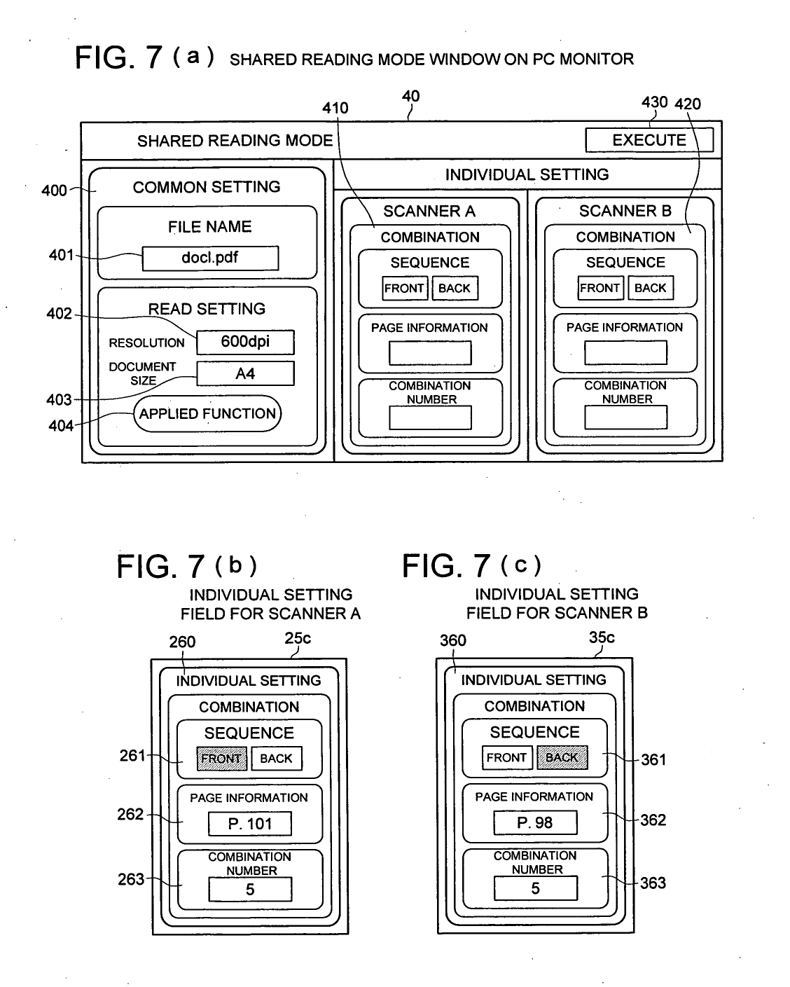

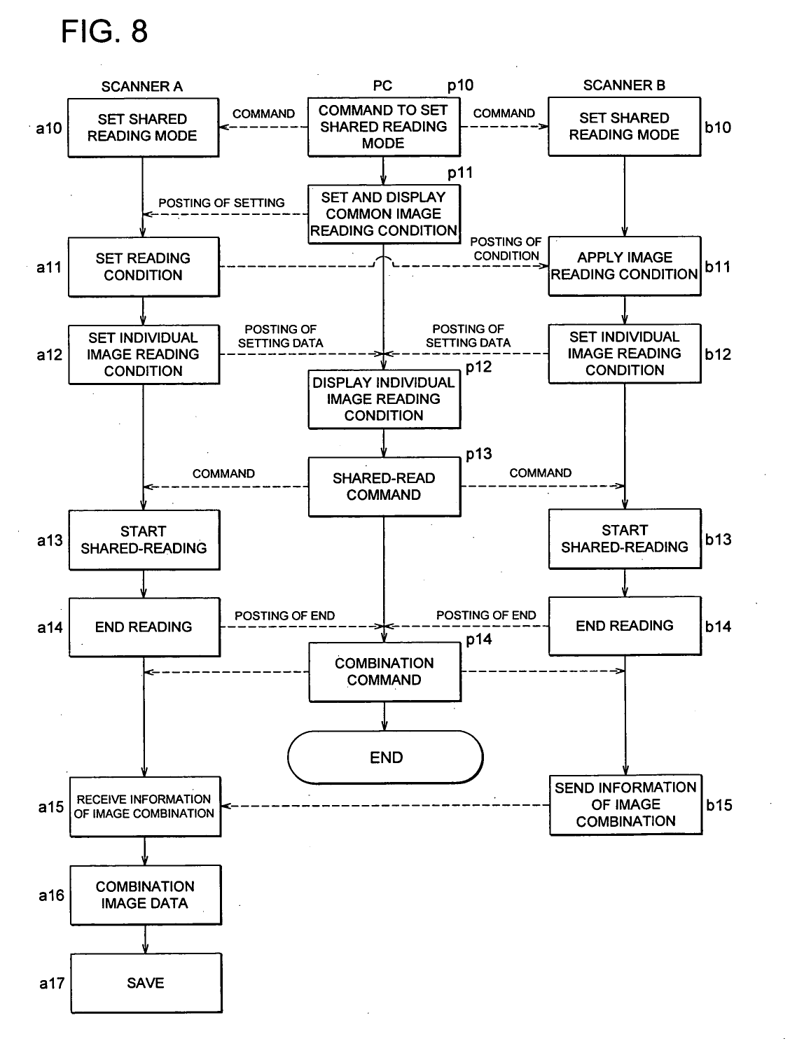

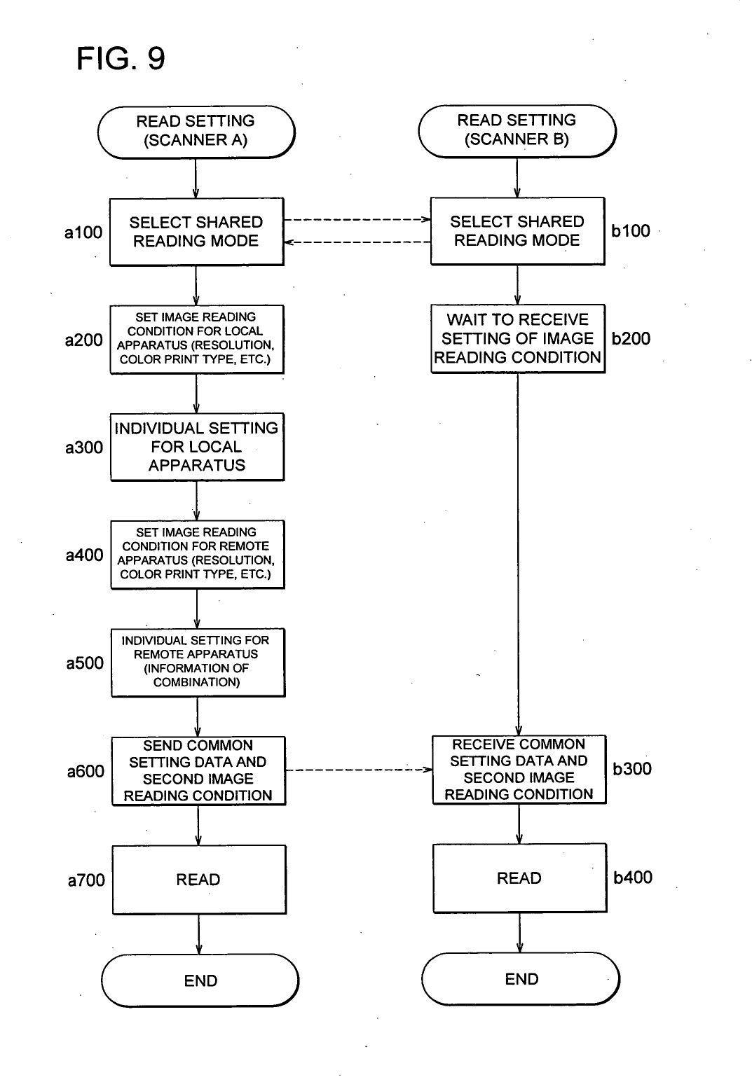

In the following description, like parts are designated by like reference numbers throughout the several drawings.

[FIG. 1] A network configuration containing an image reading apparatus which is an embodiment of this invention

[FIG. 2] An example of a display input menu which enables selection of a shared reading mode in the embodiment of this invention

[FIG. 3] A display input menu which sets a reading condition in the shared reading mode of one image reading apparatus (local) which is an embodiment of this invention

[FIG. 4] A display input menu which sets a reading condition in the shared reading mode of another image reading apparatus (remote) which is an embodiment of this invention

[FIG. 5] A flow chart of shared reading in one embodiment of this invention

[FIG. 6] A flow chart of combination of image data which is read in the dispersed mode in one embodiment of this invention

[FIG. 7] A display input menu which sets a reading condition in the shared reading mode by a computer terminal in another embodiment of this invention

[FIG. 8] A flow chart of dispersed image reading and combination of dispersed image data

[FIG. 9] A flow chart of dispersed image reading in another embodiment of this invention

### DESCRIPTION OF THE PREFERRED EMBODIMENT

Below will be explained first embodiment of this invention in reference to FIG. 1 to FIG. 6.

In a network scanner system, image reading apparatus 2 (scanner A) and image reading apparatus 3 (scanner B) are connected to a local area network (LAN) 5. Computer terminal 4 is connected to LAN 5, but will not be used in this embodiment.

Each of image reading apparatus 2 and 3 has a CPU (CPU 20 or 30) to control the whole image reading apparatus and further contains ROM (21 or 31) which stores programs and initial set data, RAM (22 or 32) as a work area to temporarily store operation data and reading condition data, and HDD (23 or 33) to store obtained image data.

Each of the image reading apparatus (2 and 3) is further equipped with a communication device (24 or 34) which has a LAN interface and its control program, an input device (25 or 35) which accepts various kinds of settings and operation commands, and a display device (26 or 36) which displays the details of settings and operating states. The image reading apparatus 2 and 3 of this embodiment are respectively equipped with a touch-sensitive panel made of a LCD which works as both an input device (25 or 35) and a display device (26 or 36).

The input devices (25 and 35) set image-reading conditions or the like and work as input devices to set image-reading conditions. Any input device such as a key input device can be used as long as it can set and enter required data. For example, a touch-sensitive panel that can set and display setting data at a time is preferable.

Each image reading apparatus (2 and 3) has a shared reading mode which enables shared-reading of a series of documents by multiple image reading apparatus and combination of the obtained image data. This shared reading mode can be selected by the above input device (25 or 35). Therefore, the input devices (25 and 35) respectively have a function as a mode input device.

Further, each image reading apparatus (2 and 3) is equipped with a reading device (27 or 37) which contains an optical system made of reading elements such as CCD, an automatic document reading device, and a data processing section. Each of the reading devices (27 and 37) is controlled by its CPU (20 or 30) which controls the whole image reading apparatus. Therefore, CPUs 20 and 30 respectively have a function as a reading control device.

The reading conditions for the image reading apparatus are not limited to particular items since image reading apparatus have specific functional differences due to production differences. Typical reading conditions may contain, for example, resolution, zooming, density, brightness, threshold values, monochromatic/color type, tone, gradation, image quality correction, and reading area.

Below will be explained the shared reading mode of the above image reading apparatus 2 and 3 in reference to FIG. 2 to 4. In the description below, this embodiment assumes that image reading apparatus 2 works as a master (local) apparatus and image reading apparatus 3 works as a slave (remote) apparatus. In actual cases, master and slave apparatus can be reversed.

The CPUs (20 and 30) and programs to run on them are designed to display input menus (25a and 35a) (see FIG. 2) to enable various kinds of settings on input devices 25 and 35. The input menu has a shared reading mode key (28 or 38) to set the shared reading mode on part of the screen.

As shown in FIG. 3 and FIG. 4, this shared reading mode key (28 or 38) has a submenu (25b or 35b) for displaying and inputting. The inputting submenu 25b which appears when the shared reading mode key 28 is pressed contains a common setting field (250) and an individual setting field (255). Each field has setting items. The displaying submenu 35b which appears when the shared reading mode key 38 is pressed contains a common setting field (250) and an individual setting field (355).

The common setting field (250) defines common shared-reading items (such as File Name, Resolution, and Document Size) and items of applied functions (such as Density, Monochromatic or Color Type, and Zooming Power). For setting of these items, the display menu (25b) has File Name setting field 251, Resolution setting field 252, Document Size setting field 253, and Applied Function setting field 254.

For setting of information about image combination, the individual setting field 255 contains Sequence Information setting field 256, Page Information setting field 257 to set the total number of pages, and Combination Number setting field 258 to set a combination number as a job number.

Meanwhile, the displaying submenu (35b) has a common setting display field (350) which contains, as setting items, File Name field 351, Resolution Field 352, Document Size field 353, and Applied Function field 354.

The individual setting field (355) contains Sequence Information setting field 356 to set image combination information, Page Information setting field 357 to set the total number of pages, and Combination Number setting field 358 to set a combination number as a job number.

Next will be explained a procedure to execute the shared reading mode in reference to FIG. 5 and FIG. 6.

When the user presses the shared reading mode key (28) on the Display Input menu (25a) of image reading apparatus 2 (scanner A in the drawing), the shared reading mode is selected (Step a1) and the communication device (27) sends information of this selection to remote image reading apparatus 3 (scanner B in the drawing) through network 5.

Image reading apparatus 2 which entered the shared reading mode displays the Display Input menu (25b) on the display device (26) and makes the input device (25) ready to display and input common setting data (Step a2).

The common setting field contains File Name setting field 251, Resolution setting field 252, Document Size setting field 253, and Applied Function setting field 254. Using these fields, predetermined reading conditions such as resolution and color-printing are set as common data. The entered common data is sent to image reading apparatus 3 by the communication device 24 through network 5 (Step a3). The user of image reading apparatus 2 sets individual reading condition items. Individual reading condition items for image combination are set using Sequence Information setting field 256, Page Information setting field 257, Combination Number setting field 258. The entered image combination information is sent by the communication device (24) to image reading apparatus 3 through network 5.

Step a1 is part of the mode setting process of this invention. Step a2 to Step a4 are equivalent to the steps of setting an image reading condition for the local image reading apparatus.

Meanwhile, when the user presses the shared reading mode key (38) of image reading apparatus 3, the shared reading mode is selected (Step b1) and the communication device (34) sends information of this selection to remote image reading apparatus 3 through network 5. An image-reading relationship between image reading apparatus 2 and 3 is established by exchanging information of selection each other. During this communication, the master-slave relationship between image reading apparatus 2 and 3 is determined. In this case, it is possible to determine, for example as a master, an image reading apparatus that first enters the shared reading mode or to determine master or slave apparatus separately on the respective image reading apparatus. This embodiment determines image reading apparatus 2, as the master (local), on which the shared reading mode is selected first and image reading apparatus 3, as the slave (remote), on which the shared reading mode is selected later. It is also possible that, after receiving information about selection of the shared reading mode from image reading apparatus 2, image reading apparatus 3 enters the shared reading mode as a slave.

When entering the shared reading mode, image reading apparatus 3 displays the Display Input menu 35b and waits to receive common setting data (Step b2). When the communication device (34) receives common setting data from image reading apparatus 2 through network 5, image reading apparatus 3 applies it to the common setting of image reading apparatus 3. The common setting data is displayed in the Common Setting field (350) of the Display Input menu (35b) of image reading apparatus 3 and can be partially modified.

The image reading conditions to be commonly set are not limited to particular ones, but some items such as Resolution, Density, and Monochromatic/color type should preferably be common.

Any network type can be used. It can be a LAN, WAN, or telephone service network. These networks can be interconnected.

The image reading apparatus can be any of an apparatus to be provided as a scanner, image forming apparatus such as a copying machine, and a multi-function machine having scanner, copier, and facsimile functions.

Further, the image reading apparatus may contain any type of communication device as long as it can transfer data through the above network, for example, LAN interface and telephone lines.

Further, the individual setting field (355) of the Display Input menu (35b) for image reading apparatus 3 contains inputs fields: Page Information setting field 57 and Combination Number setting field 358. The Sequence Information setting field (356) can be so designed that image reading apparatus 3 may automatically set sequence information which is consistent with the sequence information of image reading apparatus 2 according to the combination information sent from image reading apparatus 2. In this case, the Sequence Information setting field (356) can be so designed to reject information which is not consistent to the sequence information of image reading apparatus 2. If the sequence information set in the Sequence Information setting field (356) is not consistent to the sequence information of image reading apparatus 2, the sequence information set in the Sequence Information setting field (356) is set by the communication device (34) to image reading apparatus 2 through network 5. When receiving the sequence information, image reading apparatus 2 can automatically change it so that it may be consistent to what is set by image reading apparatus 3. This enables the user to correct the sequence of image combination without directly operating image reading apparatus 2 when finding a wrong sequence before operating image reading apparatus 3.

The above steps b2 to b4 are equivalent to a reading condition applying process which applies part of image reading information which is set by one (local) image reading apparatus to image reading condition of another (remote) image reading apparatus.

After the image reading condition is set for the image reading apparatus, their reading devices (27 and 37) respectively read images under control of CPUs (20 and 30) (Step a5 and Step b5).

It is possible to press the START button on respective image reading apparatus to start image reading. It is also possible to first place documents on both local and remote image reading apparatus, press the START button on either of the local and remote image reading apparatus, inform the other image reading apparatus of that the START button is pressed, and start image reading on both local and remote image reading apparatus.

Further, it is also possible to make one image reading apparatus to read documents from the beginning and the other image reading apparatus to read documents from the end of documents for full efficiency. In this case, page numbers of image data read backward by the other image reading apparatus should be reverse to those of image data read forward by one image reading apparatus.

Image data read by image reading apparatus 2 and 3 are processed as usual and saved in HDD 23 and 33. If either of image reading apparatus 2 and 3 detects an error such as a paper jam, it is possible to inform the occurrence of the error to the other image reading apparatus by its communication device (24 or 34) and display the error on the display devices (26 and 36).

Further, it is possible that, when one image reading apparatus detects an error, the image reading apparatus stops the shared reading, informs the occurrence of the error to the remote image reading apparatus by resetting the shared reading mode key via the communication device or network, selects the shared reading mode on the remote image reading apparatus, and informs the selection of the mode to the remote image reading apparatus via the communication device or network. With these acknowledgments, the remote image reading apparatus can make the other remote image reading apparatus continue shared-reading.

Next, respective image reading apparatus goes to a process to combine shared image data. Image reading apparatus 3 as a slave apparatus sends the obtained image data and image combination information which contains sequence information to image reading apparatus 2 by the communication device 34 through network 5 (Step b6). Image reading apparatus 2 receives the data by the communication device (24) and stores it in HDD 23 (Step a6). Image reading apparatus 2 judges the orders (sequence) of shared image data from the received image combination information (Step a7), combine shared image data in the orders into images (Steps a80 and a81), stores the resulting image data in HDD 23, and ends the shared reading mode.

As explained above, multiple image reading apparatus can read a series of documents fast by sharing the documents under the same reading condition. Naturally, it is easy to specify the order of combination of image data which is read by the other remote image reading apparatus.

Although the above embodiment uses two image reading apparatus to read documents by sharing, this invention can use three or more image reading apparatus. Further, the above embodiment uses scanners as image reading apparatus, but the image reading apparatus of this invention are not limited to scanners and further the image reading apparatus need not be of the same type.

Furthermore, part of the reading conditions is shared in the above embodiment. However, it is possible that part or all image reading apparatus share all reading conditions.

### Embodiment 2

In Embodiment 1, image reading conditions are set and applied between image reading apparatus. However, in Embodiment 2, part of image reading conditions is set by computer terminal 4 which is connected to network 5 in addition to image reading apparatus 2 and 3. The network scanner system of Embodiment 2 is the same as the above embodiment in configuration.

This embodiment enables transfer of setting data and other data between computer terminal 4 and image reading apparatus 2 and 3. The computer terminal (4) is equipped with a communication device which is not shown in the figure, a CPU which controls the whole computer terminal (4), and ROM which stores programs that run the CPU.

The computer terminal 4 can display a Display Input menu (40) to enter the image reading apparatus (2 and 3) in the shared reading mode. The user can set common image reading conditions for image reading apparatus (2 and 3) according to the menu (40). In other words, the Display Input menu (40) contains common setting field 400 which further contains File Name setting field 401, Resolution setting field 402, Document Size setting field 403, and Applied Function setting field 404. The user can set the related conditional items by these fields. Additionally, the Display Input menu (40) contains an Individual Setting field to display data which is individually set by image reading apparatus 2 and 3. Combination information field 410 of image reading apparatus 2 is designed to display Sequence information, Page information, and Combination Number. These items (Sequence information, Page information, and Combination Number) can also be displayed in the Combination Information field (420) in the individual setting of field of image reading apparatus 3.

Meanwhile, when receiving a shared reading Mode command from computer terminal 4, image reading apparatus 2 and 3 can respectively set part of image reading conditions. The reading conditions can be displayed on Individual Setting menu (25c and 35c) on display devices (26 and 36). These menus input devices (25 and 35) can accept input data.

Each Individual Setting menu contains an Individual Setting field (260 or 360) which further contains, to set image combination information, a Sequence Information setting field (261 or 361), a Page Information setting field (262 or 362) to set the total number of pages which are divided for shared-reading, and a Combination Number setting field (263 or 363).

Next will be explained a procedure for the shared reading mode in reference to FIG. 7 and FIG. 8. The user enters a Set shared reading mode command from the computer terminal 4. The communication device of the computer terminal (4) sends this command to image reading apparatus (2 and 3) through network 5 (Step p10). The command is respectively received by communication device (24 and 34) of image reading apparatus (2 and 3). CPU 20 and 30 respectively control according to the commands and set image reading apparatus 2 and 3 in the shared reading mode (Steps a10 and b10). The user of computer terminal 4 sets a preset reading condition in the Common Setting field (400) of the Display Input menu (40) (Step p11). The setting of these reading conditions is sent to the image reading apparatus (2) through network 5. Image reading apparatus 2 sets part of the image reading condition according to the content of the setting. After this setting, the image reading apparatus (2) as a master (local) sends the content of the common setting to image reading apparatus 3 by the communication device (24) through network 5. The image reading apparatus (3) receives the information by the communication device (34) and applies it to the image reading condition of the image reading apparatus (3) (Step b11).

In respective image reading apparatus (2 and 3), the user sets individual setting items such as sequence information on the Individual Setting menu (25c or 35c) (Step a12, b12). The entered individual setting is sent to the computer terminal (4) through network 5 and displayed in the Combination Information fields (410 and 420) of the Display Input menu (40) (Step p12). When confirming the entered image reading condition, the user presses the EXECUTE key (430) on the computer terminal (4). The shared reading command is sent to the image reading apparatus (2 and 3) through network 5 (Step p13). When receiving the command, the image reading apparatus (2 and 3) make the reading devices (27 and 37) to read documents according to the command and save the resulting image data in HDD (23 and 33). At the end of image reading (Steps a14 and b14), each image reading apparatus sends the end of reading to the computer terminal (4) through network 5. When confirming the end of reading by each image reading apparatus (2 and 3), the computer terminal (4) sends a command to combine image data to each image reading apparatus. The location for image combination is determined in advance by the computer terminal (4) and image reading apparatus (2 and 3). In this embodiment, the image reading apparatus (2) as a master combines and stores image data.

When receiving a command to combine image data in the other image reading apparatus, image reading apparatus 3 sends the obtained image data and information about image data combination which contains combination sequence information to image reading apparatus 2 by the communication device (34) through network 5 (Step b15). The image reading apparatus (2) receives the data by the communication device (24), combines the received image data with image data stored in the apparatus (2), stores the resulting image data in HDD 23, and ends the shared reading mode. Also in this embodiment, at least part of the image reading information which is set by one image reading apparatus is applied to the image reading information of the other image reading apparatus. This assures using of same image reading conditions between the local and remote apparatus.

The method of setting image reading conditions of image reading apparatus in accordance with the embodiment of this invention contains a process to set conditions of reading images in one image reading apparatus (that is, a reading condition setting process) and a process to apply the image reading condition to the setting of the other image reading apparatus (that is, a reading-condition applying process). Therefore, this can assure sharing of image reading conditions by applying at least part of the image reading condition which is set by one image reading apparatus to the image reading condition which is set by the other image reading apparatus.

The image reading apparatus of this embodiment is connected to the other image reading apparatus through a network and equipped with a reading device which reads document images and generates image data, a reading control device which controls the reading device under the reading condition, and a communication device which sends at least part of the reading condition to the remote image reading apparatus. Therefore, using of same image reading conditions can be assured by sending at least part of the image reading condition which is set by one image reading apparatus to the other image reading apparatus.

The image reading apparatus in accordance with the embodiment of this invention is connected to the other image reading apparatus through a network and equipped with a reading device which reads document images and generates image data, a communication device which receives an image reading condition from the other image reading apparatus, and an image-reading control device which controls the reading device by the image reading condition which is received by the communication device. Therefore, using of same image reading conditions can be assured by receiving actual image reading condition which is set by a remote image reading apparatus through a network and applying it to the image reading condition of the local image reading apparatus.

In the case the image reading apparatus has a shared reading mode which reads a series of document images by sharing them with the other image reading apparatus and the shared Reading mode is selected, sharing of image reading conditions can be assured if at least part the image reading condition is sent to the other image reading apparatus by the communication device or if at least part the image reading condition is received by the communication device from the other image reading apparatus.

Further, if the communication device sends the order (sequence) of combination of image data which is set by the (local) image reading apparatus together with the part of the image reading condition, the (remote) image reading apparatus which receives the order can set the order without fail.

Further, if the communication device receives the order (sequence) of combination of image data which is set by the other (remote) image reading apparatus together with the part of the image reading condition, the (local) image reading apparatus which receives the order can set the order without fail.

Further, if the communication device sends only sharable ones of image reading conditions of the local image reading apparatus to the remote image reading apparatus or if the communication device receives it from the remote image reading apparatus, multiple image reading apparatus can share only sharable image reading conditions. The other reading conditions can be optimized individually by respective image reading apparatus. This method can prevent wrong individual settings and set settings optimized to respective image reading apparatus.

Shared image data obtained by the above shared-reading are combined by the image reading apparatus into image data which is the same as those of a series of document pages. This enables easy and effective treatment of the resulting image data (e.g. for printing out, distribution, and storage) after that.

The combined image data can be stored in a single image reading apparatus or in multiple image reading apparatus which performed the shared reading. When the combined image data is stored in multiple image reading apparatus, it is possible to first collect image data from multiple image reading apparatus into a single image reading apparatus for combination or to send only required image data to image reading apparatus that require the image data.

In the above embodiment, multiple image reading apparatus uses the same image reading condition (Resolution, Color or Monochromatic type, Document size, File name, etc.). Therefore, all shared image data are read under the same condition. Further, respective image reading apparatus can add individual setting conditions to the common image reading condition before starting to read documents. Particularly, this enables the image reading apparatus to add combination information (image combination order, etc.) just before reading. So the user can always check the preset information and correct data if necessary before reading.

### Embodiment 3

Although Embodiments 1 and 2 in the above description use at least part of image reading conditions to set and apply between image reading apparatus, Embodiment 3 enables each reading device to set part of the image reading condition individually. The network scanner system of this embodiment is the same as the above embodiments in configuration.

Next will be explained the procedure to execute the shared reading mode in reference to FIG. 9.

When the user presses the shared reading Mode key (251) in the Display Input menu 250 of the image reading apparatus (2) (scanner A in FIG. 9), the shared reading mode is selected (Step a10). The information of this selection is sent by the communication device (27) to a remote image reading apparatus (3) (scanner B in FIG. 9) through network 5. Step a100 and later belong to the mode setting process of this invention.

The image reading apparatus (2) for which the shared reading mode is selected displays the Display Input menu (260) on the display device (26) and makes the Display Input menu ready to accept inputs as the input device (25). The Display Input menu (260) can display and accept the setting of image reading conditions (the first reading condition setting) of the local image reading apparatus (2) (Step a200). For setting of an image reading condition, the user can set a predetermined reading condition by File setting field 261, Resolution setting field 262, Document Size setting field 263, and Applied Function setting field 264 (which are already described). Therefore, this step (Step a200) is the first reading condition setting process. Then, the image reading apparatus (2) makes an individual setting for the apparatus (2) (Step a300). For this setting, the user uses Sequence Information setting field 267, Page Information setting field 268, and Combination Number setting field 269 to enter information about image combination which contains an image combination order.

Further, when the Remote Setting key (271) is pressed on the Display Input menu (260), the Display Input menu (280) is displayed to enable setting of an image reading condition of the image reading apparatus (3) (scanner B) (Step a400). In this case, if a new image reading condition is set for the image reading apparatus (3), the image reading condition set by the first reading condition setting process can be displayed as a default reading condition. The Display Input menu (280) can also set a second image reading condition which is different from the first image reading condition by entering optional conditional data. Therefore, Step a400 is the second reading-condition setting process. The reading condition items that cannot be set in the second reading-condition setting process can be set as common items for image reading apparatus 2 and 3. Using the Display Input menu (280) of the image reading apparatus (2), the user can make individual settings for the other image reading apparatus (3) (Step a500). For this individual setting, Sequence Information setting field 287, Page Information setting field 288, and Combination Number setting field 289 are used to set required image combination information. In this case, it is possible to regulate inputs in the sequence information setting field (287) to match the image sequence information set by the sequence information setting field 267. Further, it is possible to automatically change the image combination sequence for the image forming apparatus 2 when the image combination sequence is changed.

The above common setting data and the second reading-condition setting data are sent by the communication device (24) to the image reading apparatus (3) through network 5 (Step a600). The timing to send the data can be determined for example by pressing the ENTER key 272 on the Display Input menu (260 or 280). After being set by the image reading apparatus (2), the individual setting data (image combination information) for the local and remote mage reading apparatus (2 and 3) is retained in the image reading apparatus (2), for example, in HDD 23 or the like.

The second image-reading condition can be partially or wholly different from the first image-reading condition.

The image reading apparatus (3) enters the shared reading mode, for example, when the shared reading mode key (251) is pressed on the image forming apparatus (2) (Step b100). It is possible to make the communication device (34) to send the information of mode selection to the remote image forming apparatus (3) through network 5 when the shared reading mode key is selected in the image reading apparatus (3). By selecting the mode by a single image reading apparatus or mutually by the local and remote image reading apparatus, the master-slave relationship of the image reading apparatus is determined. In the determination of the master-slave relationship, it is possible to determine, for example as a master (local), an image reading apparatus that first enters the shared reading mode or to determine master or slave (remote) apparatus separately on the respective image reading apparatus. This embodiment determines image reading apparatus 2, as the master, on which the shared reading mode is selected and image reading apparatus 3, as the slave, on which the shared reading mode is selected later.

When entering the shared reading mode, the mage reading apparatus (3) waits to receive the setting of the image reading condition (Step b200). When received by the communication device 34 from the image reading apparatus (2) through network 5, the common setting data and the second reading condition data (which is set by the image reading apparatus (2)) is applied to the image reading condition for the image reading apparatus (3) (Step b300). In other words, Step a600 and Step b300 are respectively equivalent to the common reading-condition applying process and the second reading-condition applying process of this invention.

After the above conditions are set, the reading devices (27 and 37) of the image reading apparatus (2 and 3) read images under control of their CPUs (20 and 30) (Step a700 and Step b400).

By the way, it is possible to start image reading when the Document Read key is pressed on respective image reading apparatus. It is also possible to place documents on both local and remote image reading apparatus, press the Document Read key (252) on one of the image reading apparatus, for example, a master image reading apparatus (2), send the result of depression of the Document Read key to the other image reading apparatus, and thus make both local and remote image reading apparatus to start image reading.

It is also possible to make one image reading apparatus to read documents from the beginning and the other mage reading apparatus to read documents from the end of documents for full efficiency. In this case, page numbers of image data read backward by the other image reading apparatus should be reverse to those of image data read forward by one image reading apparatus.

Image data read by image reading apparatus 2 and 3 are processed as usual and saved in HDD 23 and 33. If either of image reading apparatus 2 and 3 detects an error such as a paper jam, it is possible to send the occurrence of the error to the other image reading apparatus by its communication device (24 or 34) and display the error on the display devices (26 and 36).

Further, it is possible that, when one image reading apparatus detects an error, the image reading apparatus stops the shared reading, sends the occurrence of the error to the remote image reading apparatus by resetting the shared reading mode key via the communication device or network, selects the shared reading mode on the remote image reading apparatus, and sends the selection of the mode to the remote image reading apparatus via the communication device or network. With these acknowledgments, the remote image reading apparatus can make the other remote image reading apparatus continue shared-reading.

Next, respective image reading apparatus goes to a process to combine shared image data. This process is the same as what is explained for the above embodiments (see FIG. 6) and will not be explained here.

As explained above, multiple image reading apparatus can read a series of documents fast by sharing the documents under the same reading condition. Naturally, it is easy to specify the order of combination of image data which is read by the other remote image reading apparatus.

Although the above embodiment uses two image reading apparatus to read documents by sharing, this invention can use three or more image reading apparatus. Further, the above embodiment uses scanners as image reading apparatus, but the image reading apparatus of this invention are not limited to scanners and further the image reading apparatus need not be of the same type.

Furthermore, the above embodiment sets a second image-reading condition which is partially different from the first image-reading condition, but this invention contains a case in which one or all image reading apparatus have different image-reading conditions.

The method of setting image reading conditions for image reading apparatus in accordance with this invention contains a first step for setting an image reading condition for one (first) image reading apparatus by an operating section of the image reading apparatus and a second step for setting another image reading condition for another (second) image reading apparatus (which is different from the image reading condition for the first image reading apparatus) by the operating section of the first image reading apparatus. Therefore, the first image reading apparatus can set a second image reading condition for the second image reading apparatus.

The image reading apparatus in accordance with the embodiment is a image reading apparatus connected to another image reading apparatus through a network and equipped with a reading device which reads document images and generates image data, an operating section to set reading conditions of document images, an image-reading control device which controls the reading device under the image reading condition which is set by the operating section, and a communication device which sends a second image-reading condition (which is set by the operating section and different from the first image-reading condition) to the another image reading apparatus. Therefore, the image-reading condition for multiple image reading apparatus in a network can be easily set by a single image reading apparatus which is in the network since the second image-reading condition set by the image reading apparatus can be send to the other image reading apparatus in the network.

Further, since the image reading conditions of the other image reading apparatus can be checked easily during setting, the user can set required different image-reading conditions while monitoring the reading conditions of the other image reading apparatus.

In the case a first image reading apparatus has a shared reading mode which reads a series of document images by sharing them with a second image reading apparatus and the second image reading condition is sent to the second image reading apparatus when the shared reading mode is selected, the second image reading apparatus can steadily use its image-reading condition which is set by the first image reading apparatus in the shared reading mode.

Further, if the communication device sends information of an image combination order which is set by the first image reading apparatus is sent to the second image reading apparatus together, the second image reading apparatus can set the combination order correctly.

Further, if the communication device of the first image reading apparatus sends part of the first image reading condition for the first image reading apparatus (which is also used in common by the second image reading apparatus) to the second image reading apparatus, the common part of the first image reading condition can be used by multiple image reading apparatus. The other part of the second image reading condition can be optimized together with the first image reading condition by the operating section of the first image reading apparatus. Further, it is possible to set an image reading condition fit for respective image reading apparatus by setting a second image reading condition which is different from the first image reading condition.

The shared image data obtained by the above shared-reading are combined by the image reading apparatus into image data which is the same as those of a series of document pages. This enables easy and effective treatment of the resulting image data (e.g. for printing out, distribution, and storage) after that.

The combined image data can be stored in a single image reading apparatus or in multiple image reading apparatus which performed the shared reading. When the combined image data is stored in multiple image reading apparatus, it is possible to first collect image data from multiple image reading apparatus into a single image reading apparatus for combination or to send only required image data to image reading apparatus that require the image data.

The setting information (Resolution, Color or Monochromatic type, Document size, File name, etc.) of the obtained image data is made different at least partially so that images may be read under conditions fit for the image reading apparatus. Further, this enables the image reading apparatus to set combination information (image combination order, etc.) just before reading. So the user can always check the preset information and correct data if necessary before reading.

In the above descriptions are described several embodiments to illustrate the invention. However, it is to be understood that the invention is not intended to be limited to the specific embodiments and variations may be made by one skilled in the art without departing from the spirit and scope of the invention.

What is claimed is:

1. A reading condition setting method for an image reading apparatus comprising the steps of:
setting a reading condition for reading an image to a local image reading apparatus; and
applying at least a part of the reading condition to an image reading by a remote image reading apparatus.

2. The method of claim 1, further comprising the step of setting a shared reading mode to make multiple image reading apparatus which contain at least the local and the remote image reading apparatus to read a series of document pages by sharing the document pages with the local and remote image reading apparatus, wherein the step of applying is executed when the shared reading mode is set.

3. The method of claim 2, wherein the shared reading mode combines image data which is obtained by the multiple image reading apparatus by means of shared-reading.

4. The method of claim 1, wherein the reading condition to be applied to the remote image reading apparatus is only a part of the reading conditions that are set for the local image reading apparatus in the step of setting the reading condition and is to be same between the local and the remote image reading apparatus.

5. An image reading apparatus having a local image reading apparatus which communicates with a remote image reading apparatus through network, comprising:
a reading device to read an image of a document and to obtain image data;
a control device to control the reading device according to a reading condition; and
a communication device to send at least a part of the reading condition to the remote reading apparatus.

6. The image reading apparatus of claim 5, further comprising an input device which enters the reading condition.

7. The image reading apparatus of claim 5, wherein the image reading apparatus has a shared reading mode which the local and remote image reading apparatus read images of a series of document pages by sharing the document pages and the communication device sends at least part of the reading conditions to the remote image reading apparatus when the Shared Reading mode is selected.

8. The image reading apparatus of claim 7, further comprising a mode input device which selects the shared reading mode.

9. The image reading apparatus of claim 7, wherein the Shared Reading mode combines image data which is obtained by the local and remote image reading apparatus by shared-reading.

10. The image reading apparatus of claim 8, wherein the shared reading mode combine image data which is obtained by the local and remote image reading apparatus by shared-reading and the mode input device determines the order of combination of image data.

11. The image reading apparatus of claim 10, wherein the order of combination of image data determined by the mode input device is further transmitted.

12. The image reading apparatus of claim 5, wherein only a part of the reading conditions, which is made by the local image reading apparatus and is to be same between the local and the remote image reading apparatus, is sent to the remote image reading apparatus.

13. An image reading apparatus having a local image reading apparatus which communicates with a remote image reading apparatus through network, comprising:
a reading device to read an image of a document and to obtain image data;
a control device to control the reading device according to a reading condition; and
a communication device to send at least a part of the reading condition to the remote reading apparatus.

14. The image reading apparatus of claim 13, wherein the image reading apparatus has a shared reading mode which the local and remote image reading apparatus read images of a series of document pages by sharing the document pages and the read control device controls the reading device according to at least part of the reading condition received by the communication device in the shared reading mode.

15. The image reading apparatus of claim 14, wherein the shared reading mode combines image data which is obtained by the local and remote image reading apparatus by shared-reading.

16. The image reading apparatus of claim 15, wherein the communication device receives the order of combination of image data obtained by the local image reading apparatus with image data obtained by the remote image reading apparatus.

17. The image reading apparatus of claim 15, wherein a mode input device is provided to select the shared reading mode.

18. The image reading apparatus of claim 7, wherein the shared reading mode is set by a shared reading Mode command which the communication device received.

19. The image reading apparatus of claim 14, wherein the shared reading mode is set by a shared reading mode command which the communication device received.

20. The image reading apparatus of claim 8, wherein the mode input device can select the shared reading mode while the document is reading.

21. The image reading apparatus of claim 17, wherein the mode input device can select the shared reading mode while he document is reading.

22. The image reading apparatus of claim 7, wherein, when the communication device receives a mode release acknowledgement from the remote image reading apparatus which reads images of a series of document pages by sharing with the local image reading apparatus and receives a mode selected acknowledgement from another remote image reading apparatus, the another remote image reading apparatus continues the shared reading mode with the another remote image reading apparatus.

23. The image reading apparatus of claim 14, wherein, when the communication device receives a Mode Release acknowledgement from the remote image reading apparatus which reads images of a series of document pages by sharing with the local image reading apparatus and receives a mode selected acknowledgement from another remote image reading apparatus, the another remote image reading apparatus continues the shared reading mode with the another remote image reading apparatus.

24. The image reading apparatus of claim 7, wherein, when a problem occurs in the shared reading mode, the communication device informs the remote image reading apparatus of the problem.

25. The image reading apparatus of claim 14, wherein, when a problem occurs in the shared reading mode, the communication device informs a remote image reading apparatus of the problem.

26. The method of claim 1, wherein the step for setting image reading conditions contains a first substep for setting an image reading condition for the local image reading apparatus by an operating section of the local image reading apparatus and a second substep for setting another image reading condition for a remote image reading apparatus which is different from the image reading condition for the local image reading apparatus by the operating section of the local image reading apparatus, and the step for applying the image reading condition applies the image reading condition which is set by the local image reading apparatus to the image reading condition of the remote image reading apparatus.

27. The method of claim 26, wherein a mode setting step is provided to set a shared reading mode which makes multiple image reading apparatus which contain at least the local image reading apparatus and the remote image reading apparatus to read images of a series of document pages by sharing the document pages with the local and remote image reading apparatus, and the second step of setting the image reading condition is executed when the shared reading mode is set by the mode setting step.

28. The method of claim 26, comprising the second reading condition which is set by the second substep of setting image reading conditions to the remote image reading apparatus.

29. The method of claim 26, wherein the step of applying the image reading conditions applies a part of the image reading conditions set by the first step of setting the image reading conditions to another part of the image reading conditions set of the remote image reading apparatus

30. The image reading apparatus of claim 5, comprising,
an operating section to set the image reading condition,
wherein the reading condition contains a first reading condition and a second reading condition which is not equal to the first reading condition,
the reading control device controls the reading device by the first reading condition, and
the communication device sends at least part of the first reading condition and the second reading condition to the remote image reading apparatus.

31. The image reading apparatus of claim 30, wherein the image reading apparatus has a shared reading mode which the local and remote image reading apparatus read images of a series of document pages by sharing the document pages and the communication device sends the second reading condition to the remote image reading apparatus when the shared reading mode is selected.

32. The image reading apparatus of claim 30, wherein the communication device can send a part of the first reading condition together with the second reading condition to the remote image reading apparatus.
